(19) United States
(12) Patent Application Publication
(10) Pub. No.: US 2016/0246295 A1
(43) Pub. Date: Aug. 25, 2016

(54) METHOD FOR INVESTIGATING A CAUSE OF A FAILURE OF A COMPONENT OF A DRIVE MACHINE

(71) Applicant: FEV GMBH, Aachen (DE)

(72) Inventors: Holger Pieta, Eschweiler (DE); Volker Müller, Aachen (DE); Bernd Wolkenar, Aachen (DE)

(21) Appl. No.: 15/046,744

(22) Filed: Feb. 18, 2016

(30) Foreign Application Priority Data
Feb. 20, 2015 (DE) 102015203103.9

(51) Int. Cl. G05B 23/02

(52) U.S. Cl. CPC G05B 23/0254

(57) ABSTRACT

In the method for investigating the cause of a failure of a component of a drive machine, such as an internal combustion engine, an electric drive or a hybrid drive for example, in particular an emissions-related component of an internal combustion engine, in particular in a motor vehicle, the internal combustion engine supplies at least two characteristic values during operation. Each characteristic value is compared with a threshold value. Appropriate diagnosis messages are generated depending on the respective results of the comparisons. At least one diagnosis message indicates a failure. A potential cause or potential causes of the failure or failures is/are diagnosed and corresponding fault messages are generated on the basis of the diagnosis message or diagnosis messages. A position in a ranking is associated with each fault message, where the ranking represents the relative probabilities of the presence of the respective associated causes.

### CROSS-REFERENCE TO RELATED APPLICATIONS

This application claims priority of German Patent Application 10 2015 203 103.9 filed Feb. 20, 2015.

### FIELD OF THE INVENTION

The invention relates to a method for investigating the cause of a failure of a component of a drive machine. The invention can be used, in particular, in OBD (On-Board Diagnosis) systems of motor vehicles, specifically in the form of an extension to the monitoring and diagnosis options of vehicles in everyday use by it being possible for the OBD system, which is mandatory in many countries for monitoring, in particular, the engine functions in respect of exhaust emissions, to be supplemented with further diagnosis capabilities.

### BACKGROUND OF THE INVENTION

The prior art for OBDs is that in each case only one occurring error, which is established for relevant engine monitoring variables when certain preset threshold values are exceeded, is displayed and can be read off from the engine control device. Further information is not used in this case.

The invention proceeds from a method for diagnosing the fault in a machine, in which method the at least one characteristic value is compared with at least one threshold value in order to trigger an error message. A fault, that is to say an abnormal behavior of a component of the machine (for example a structural element, a sensor or an actuator), can lead to at least one failure of the machine or one of the components of the said machine, that is to say at least one function of the machine or at least one function of one of the components of said machine can no longer be correctly fulfilled. Faults or failures generate at least one error, that is to say a deviation in the measured value of a characteristic value from the expected measured value of this characteristic value in the case of a fault-free system.

The method respectively sets an error message when, under respectively determined, known boundary conditions, one of these errors can be measured and is significant, that is to say when the corresponding characteristic value exceeds a corresponding upper threshold value or when the corresponding characteristic value undershoots a corresponding lower threshold value, with a separate error message being set for each of the two described cases. The method respectively sets an OK message when, under the same specific and known boundary conditions, the respective error cannot be measured or can be measured but is not significant, that is to say when the respective characteristic value lies above the respective lower threshold value and at the same time below the respective upper threshold value. The method can therefore output three different diagnosis messages for each comparison of a characteristic value with a threshold value: firstly, comparison not yet concluded; secondly, comparison concluded and no significant errors identified (that is to say OK message); thirdly, comparison concluded and significant errors identified (that is to say error message).

The method is terminated after a first error message has been output since the system is therefore faulty.

DE 10 2006 021 306 B3 has already disclosed a method which identifies a possibly faulty component of a motor vehicle by jointly examining a plurality of standardized characteristic values.

DE 10 2009 044 076 A1 discloses a method for identifying errors in the fuel injection of an internal combustion engine, with at least one characteristic variable being determined during operation and then a comparison being carried out between an operating value, which is determined from the characteristic variable, and a reference value, with a plurality of operating values being determined and being compared with an associated reference value in each case in order to then determine a relationship between the results of the individual comparisons between the operating values and the associated reference values and to distinguish between different errors and to identify an error.

### SUMMARY OF THE INVENTION

The object of the invention is to improve and to extend the diagnosis options for faults in connection with the monitoring of drive machines.

In order to achieve this object, the invention proposes a method for investigating the cause of a failure of a component of a drive machine, such as an internal combustion engine, an electric drive or a hybrid drive for example, in particular an emissions-related component of an internal combustion engine, in particular in a motor vehicle, where, in the method,
the internal combustion engine supplies at least two characteristic values during operation,
each characteristic value is compared with at least one threshold value,
appropriate diagnosis messages are generated depending on the respective results of the comparisons,
at least one diagnosis message indicates a failure,
a potential cause or potential causes of the failure or failures is/are diagnosed and corresponding fault messages are generated on the basis of the diagnosis message or diagnosis messages, and
a position in a ranking is associated with each fault message, where the ranking represents the relative probabilities of the presence of the respective associated causes.

The invention analogously proposes a method in which a group of a plurality of existing error messages is analyzed in respect of a cause, where further operating data of the internal combustion engine—possibly also relating to the operating situation and driving situation of the vehicle—can also be used in order to determine, from the group of error messages and operating data, the cause of an error or a fault with a degree of probability. Furthermore, a ranking of the possible causes of the error is generated on the basis of the determined probabilities. This is advantageously done on the basis of all of the available information, the completeness of this information and the agreement with the expected results. The ranking is advantageously updated, either automatically or upon instruction, when new results which differ from the previous situation are produced. The term “probability” is also intended to be understood to mean assessments which include assignment of specific, predefined and/or calculated values to the respective faults but, for example, do not necessarily correlate with the frequency of the occurrence.

In an expedient development of the invention, it can be provided that the ranking is established on the basis of a prespecifiable criterion, such as the relevance of a failure, which is associated with a fault message, for maintaining/adversely affecting proper operation of the drive machine for example, or on the basis of mathematically determined probability values.

It may be advantageous when the ranking is determined on the basis of each individual diagnosis message or on the basis of the type of diagnosis messages and all of said diagnosis messages or a combination of said diagnosis messages.

In the case of a drive machine which can be operated in a plurality of operating states, a respectively constant threshold value can be used for all of the operating states.

In the case of a drive machine which can be operated in a plurality of operating states, different respectively constant threshold values can be used for different operating states as an alternative.

Furthermore, it may be expedient when a measured value or a control loop reference variable in the form of a deviation of an actual value or measured value from a setpoint value is used as at least one of the characteristic values.

It is advantageous when the trustworthiness of the ranking of the fault messages is assessed, in particular when the available information is incomplete or contradictory.

It can further be provided that operating states for the drive machine are prespecified on the basis of the diagnosis messages, the drive machine possibly having to be operated in a likewise prespecified sequence and/or possibly having to be operated with a likewise prespecified chronological order in said operating states, in order to acquire further information in order to increase the trustworthiness of the ranking of the fault messages. The controller of the drive machine (for example the driver of a motor vehicle) or the maintenance staff receives instructions for carrying out a test program, provided that this is not associated with an undesired hazard potential.

It is advantageous when at least one comparison of characteristic value and setpoint value indicates a fault, the type and/or degree of said fault being dependent on the amount by which the characteristic value exceeds or undershoots the setpoint value.

It may equally be advantageous when at least one comparison of characteristic value and setpoint value generates a diagnosis message, the type and/or degree of said diagnosis message being dependent on the operating state of the drive machine in which state the diagnosis message is generated.

In a development of the invention, operating states for the drive machine are induced by the control system on the basis of the diagnosis messages, the drive machine being automatically operated in a prespecified sequence and/or with a prespecified chronological order in said operating states, in order to acquire further information in order to increase the trustworthiness of the ranking of the fault messages. In this case, the drive machine carries out the test program automatically, provided that this does not result in undesired hazard situations.

The invention can be used primarily in a diagnosis device for a motor vehicle having an internal combustion engine, with the diagnosis device operating according to a method according to one of the preceding statements.

The method according to the invention has the advantage that further comparisons are executed after the first error message and therefore the combination of the different diagnosis messages can be used in order to create a ranking of the probably causal faults. Each fault triggers a pattern or a specific combination of diagnosis messages, so that a ranking can be created with the method by analyzing the identified diagnosis messages, said ranking representing the relative probabilities of the presence of the possible faults. Diagnosis messages which were determined before the first error message are preferably not used to identify the cause. This prevents the result being corrupted.

In a further advantageous embodiment of the method according to the invention, the ranking is created before all possible diagnosis messages are generated. In this way, it is possible to make a statement about a possible and/or probable causal fault. The further procedure can then be geared towards rapid, unambiguous identification of the causal fault in an optimum manner on the basis of this information.

The terminology used in connection with the description of the invention is based on ISO 26262 which provides the following definitions:
Fault: cause of a failure (for example physical defect such as leak)
Failure: system/machine not functioning properly (setpoint pressure cannot be built up)
Error: deviation between actual value and setpoint value or measured value and setpoint value

A diagnosis monitors specific measured values. If the error of this measured value is too great, a failure of the system is identified. The method according to the invention then serves to identify the cause of this failure, that is to say the fault.

The threshold value which is used for the comparison can be present in a different form: the threshold value can be a value which does not change over time and is read out from a memory for example, or can be a value which is dependent on the operating period, the operating point, the operating conditions or other boundary conditions, as a result of which narrower thresholds can be selected depending on conditions. Said threshold value can likewise be provided as an absolute value or as a value relative to the expected measured value of the respective characteristic value of a fault-free system. The method can likewise compare the respective fault of a characteristic value with an absolute or relative threshold value of the fault in order to generate a diagnosis message. In the above cases, the threshold value is in each case a model value of the expected characteristic value, with a threshold value which does not change over time representing the simplest example of a model. Threshold values which change over time are generally dependent on other specific characteristic values. For comparison purposes, the method can also use characteristic values which are calculated from the deviation between the setpoint value and the actual value of a value which is subjected to closed-loop control or open-loop control, as a result of which analysis of the influence of the fault on closed-loop control operations or open-loop control operations is made possible.

By evaluating the completeness of the combination of diagnosis messages, it is possible to derive a statement about the trustworthiness of the ranking of the possible faults, so that a further-reaching diagnosis can be recommended. Derived from this, it is further possible to recommend operating procedures for the machine which are particularly suitable for making further comparisons and thereby maximizing the trustworthiness of the ranking, which represents the relative probabilities of the presence of the possible faults, as rapidly as possible. On the basis of these recommendations, the method can carry out an additional test program using the control system or can provide handling instructions to the maintenance staff, for example by means of a diagnosis interface, or to the machine controller, for example by a man/machine interface. The diagnosis method can therefore also be triggered by maintenance staff, as a result of which, in the event of a suspected fault, the staff are assisted in identifying the fault using checking routines which are carried out by the control system. The method can likewise also be initially triggered by an error message.

### BRIEF DESCRIPTION OF THE DRAWINGS

Exemplary embodiments of the invention are explained in greater detail in the following description and illustrated in the drawings, in which:

FIG. 1 shows a schematic view of an internal combustion engine which operates in accordance with the diesel method and has a control apparatus, and

FIG. 2 shows a qualitative illustration of possible combinations of diagnosis messages for various faults in the internal combustion engine from FIG. 1.

### DETAILED DESCRIPTION OF THE INVENTION

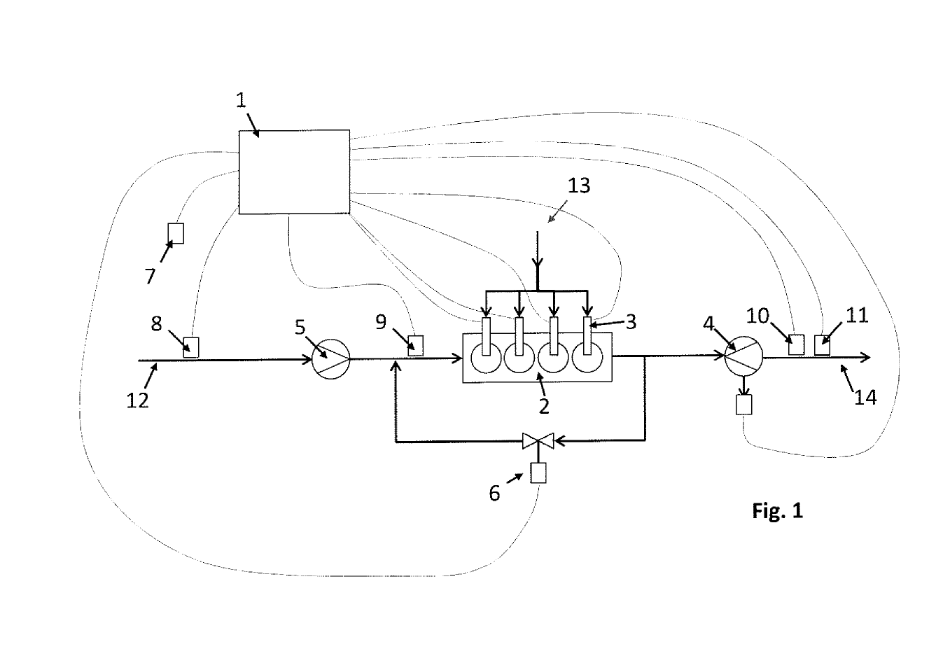

FIG. 1 schematically shows an internal combustion engine 2 having four combustion chambers. Air is supplied to the combustion chambers via the air supply line 12 and fuel is supplied via a fuel supply line 13 by means of an injection system 3. In the combustion chamber, the fuel is burnt with the air, and the resulting exhaust gases are carried away via an exhaust gas pipe 14. Inlet valves and outlet valves for the air flow and, respectively, the exhaust gas flow are not illustrated for the sake of simplicity. The method according to the invention can also be used in other drive machines. A large number of sensors, actuators and structural elements which are evaluated by a control apparatus 1 or are driven by the control apparatus 1 are provided for controlling the internal combustion engine and for meeting specific operating conditions. FIG. 1 illustrates some of these components by way of example. The internal combustion engine has an exhaust gas turbocharger which in turn comprises a turbine 4 and a compressor 5. The exhaust gas flow is expanded in the turbine and thereby performs mechanical work on the turbine. An adjustment apparatus which is driven by the control apparatus 1 can be used to set the amount of work performed. The turbine 4 drives the compressor 5 via a mechanical shaft which is not illustrated for reasons of simplicity. The compressor 5 compresses the inflowing air and therefore increases the pressure and the temperature in the intake pipe. The intake pipe pressure sensor 9 measures the gas pressure in the intake pipe and sends this measurement to the control apparatus 1. Furthermore, an air mass flow sensor 8 measures the fresh air mass flow flowing into the internal combustion engine. The internal combustion engine illustrated furthermore has an apparatus for returning some of the exhaust gas flow to the intake pipe, wherein this mass flow of the returned exhaust gas can be set by the control apparatus 1 via a valve 6. This method is used in order to reduce the formation of nitrogen oxides (NOx) during the combustion process. The control apparatus uses the information from the intake pipe pressure sensor 9, the engine rotation speed and possibly other variables in order to determine the gas mass flow flowing into the combustion chambers and to determine the mass flow of the returned exhaust gas with the aid of the air mass flow sensor 8. Furthermore, the internal combustion engine illustrated has a broadband lambda probe 10 for determining the combustion air ratio which is defined as the ratio of the air mass involved in the combustion process to the air mass which is required for a complete and stoichiometric combustion process. In this way, the fuel mass flow can be determined with the aid of the air mass flow which is measured by the air mass flow sensor 8. The system also has a sensor for determining the nitrogen oxide concentration in the exhaust gas (NOx sensor 11) and an ambient pressure sensor 7. The control apparatus uses the sensor values from the sensors 7, 8, 9, 10 and 11 in order to adjust the intake pipe pressure and the mass flow of the returned exhaust gas depending on the operating point, that is to say depending on the engine rotation speed and the required power output. The quantity of metered fuel for a specific engine rotation speed is given directly by the required power output. The operating conditions which are set in this way produce specific measured values from the sensors given specific ambient conditions and a fault-free, that is to say intact, system.

The method according to the invention executes a series of different diagnosis functions, that is to say it compares the measured value from a sensor with a corresponding setpoint value or a corresponding model value. If the measured value deviates excessively from the setpoint value which is to be set given these operating and ambient conditions or the model value which is to be expected, a corresponding error message is triggered. In the example illustrated here, the method according to the invention is carried out in the control apparatus 1. The reactions of the system to four different faults are described by way of example. These faults are:
A. Leak in the air supply upstream of the compressor 5
B. Leak in the air supply downstream of the compressor 5
C. Increased fuel mass flow through the injection valves 3
D. Reduced fuel mass flow through the injection valves 3

In the present example, the method carries out four comparisons:
I. The measured value from the intake pipe pressure sensor 9 is compared with the model value of the intake pipe pressure.
II. The measured value from the air mass flow sensor 8 is compared with the model value of the air mass flow.
III. The measured value from the broadband lambda probe 10 is compared with the model value of the combustion air ratio.
IV. The measured value from the NOx sensor 11 is compared with the model value for the nitrogen oxide concentration in the exhaust gas.

The comparisons are each carried out only under specific defined operating conditions of the internal combustion engine. In this example, the operating conditions are selected such that all of the comparisons are carried out and the diagnosis messages are present. Each of these comparisons is compared with two threshold values—an upper threshold value and a lower threshold value—in this example. If the measured value deviates downward from the corresponding setpoint value or model value by more than the lower threshold value in this case, a corresponding first error message is dispatched. If the measured value deviates upward from the corresponding setpoint value or model value by more than the upper threshold value, another corresponding second error message is dispatched. If the measured value lies within the threshold values, an OK message is dispatched. The individual threshold values are selected such that an error message is triggered as soon as unsuitable operating states of the machine can no longer be reliably precluded, it being possible for said operating states to lead to the machine being at risk, or as soon as the statutorily permitted operating range is left, for example when the on-board diagnosis limit values are exceeded in the case of a passenger car. In this case, the individual faults can influence the comparisons in two ways: either directly by leading to a change in the measured values, or indirectly by being an input variable for the respective model and thereby influencing the model value.

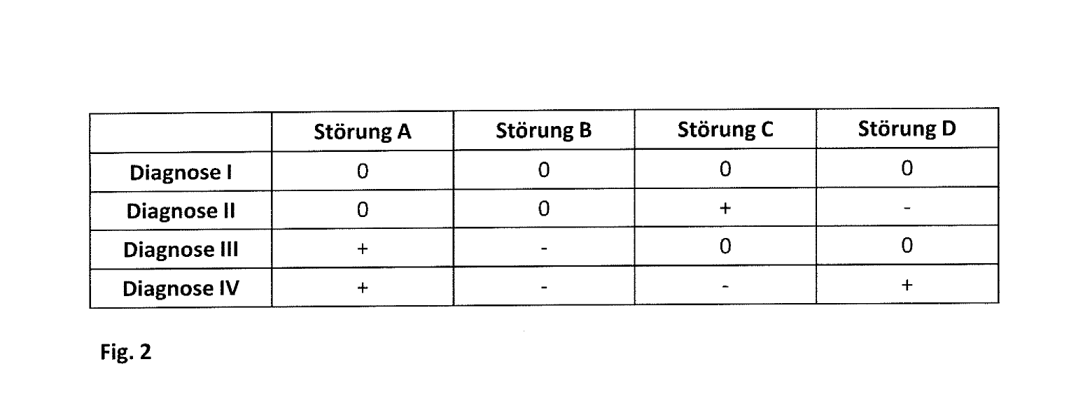

FIG. 2 shows the combination of diagnosis messages for this example. In said figure, a plus sign represents an implausibly high measured value, that is to say the measured value exceeds the upper threshold value. A minus sign represents an implausibly low measured value, that is to say the measured value undershoots the lower threshold value. A zero represents an OK result, that is to say a plausible measured value which lies within the lower threshold and the upper threshold.

If fault A, that is to say a leak upstream of the compressor 5, occurs in the system, air which is not measured by the air mass flow sensor 8 is drawn into the system on account of the negative pressure at this point. Therefore, the pressure in the intake pipe increases owing to the greater compressed air mass. The control apparatus is then readjusted to the desired values by matching the valve position 6 and the turbine geometry 4 to the intake pipe pressure and to the air mass flow. This in turn leads to a relatively low proportion of returned exhaust gas in the gas mixture which is supplied to the combustion chambers, and therefore to higher NOx concentrations in the exhaust gas than in the fault-free system. Furthermore, the proportion of fresh air in this gas mixture will increase, this leading to a larger combustion air ratio than in the fault-free system. However, model values of the individual variables are calculated with an air mass which is lower than that actually used, and will therefore deviate from the measured values. This therefore results, for example, in the combination of diagnosis messages illustrated in FIG. 2 for fault A.

However, if fault B, that is to say a leak downstream of the compressor 5, occurs in the system, the excess pressure at this point causes air which has already been measured by the air mass flow sensor to be blown out of the system. The combination of diagnosis messages illustrated in FIG. 2 for fault B result after the setpoint values for the intake pipe pressure and the air mass flow are adjusted. Faults C and D likewise lead to characteristic combinations of diagnosis messages which are likewise illustrated in FIG. 2 by way of example.

If a fault then occurs in the machine, a sequence which lists the most probable causes on the basis of the combination can be created on the basis of the method according to the invention, even if not all of the comparisons have yet been evaluated. If, for example, a positive deviation is identified by diagnosis IV in the system illustrated in FIG. 2, the probability that fault A or fault D is the cause is equally high; however, it is improbable that fault B or fault C is the cause.

The method can also be used to identify that diagnosis I does not provide any additional information for any faults considered in this example, and in particular in this case. The method can request operating states from the control device or the machine controller, which operating states allow one of the diagnoses I or II to be carried out in order to then be able to decide which of the faults A or D is the more probable cause of the failures.

In this case, the combinations are highly dependent on the machine under consideration and, for example in case of internal combustion engines of different production series, can vary depending on which method is used for subjecting the machine to open-loop control or closed-loop control, how the machine reacts to the individual faults and how the individual threshold values have been selected. It is therefore necessary for the combinations of diagnosis messages for each fault to be experimentally determined, where as many faults as possible should be investigated for the purpose of identification which is as accurate as possible.

As an alternative, the invention can also be described by one of the following groups of features:
1. A method for identifying a fault in a machine, in which method at least two characteristic values are compared with in each case at least one threshold value in order to trigger a large number of possible error messages, wherein the combination of diagnosis messages is used, and wherein a ranking of the probable faults is determined.
2. The method according to point 1, wherein at least one fixed threshold value, which is read out from a memory, is used.
3. The method according to either of the preceding points, wherein at least one threshold value which is dependent on the operating states of the machine is used.
4. The method according to one of the preceding points, wherein at least one characteristic value which is calculated from the deviation between the setpoint value and the actual value of a value which is subjected to closed-loop control or open-loop control is used for the comparison.
5. The method according to one of the preceding points, wherein the trustworthiness of this ranking is assessed.
6. The method according to point 5, wherein the operating procedures of the machine which lead to an increase in this trustworthiness are described.
7. The method according to one of the preceding points, wherein at least one comparison of characteristic value and threshold value triggers error messages which are dependent on the amount by which the threshold value is exceeded or undershot.
8. The method according to one of the preceding points, wherein at least one comparison of characteristic value and threshold value triggers error messages which are dependent on operating states of the machine.
9. The method according to one of the preceding points, wherein, when a possibly faulty component is identified, an additional test program is run by the control system in order to identify the cause of the possible error.
10. The method according to points 6 and 9, wherein the control system provides the maintenance staff with handling instructions in order to induce operating procedures of the machine which lead to an increase in the trustworthiness.
11. The method according to points 6 and 9, wherein the control system provides the machine controller with handling instructions in order to induce operating procedures of the machine which lead to an increase in the trustworthiness.
12. The method according to one of the preceding points, wherein the diagnosis method is triggered by the maintenance staff.
13. A control apparatus for controlling a motor vehicle, which control apparatus compares at least two characteristic values with in each case at least one threshold value for the purpose of identifying a fault in a motor vehicle, with the combination of set and unset error messages being used in order to determine a ranking of the probabilities of the possible faults according to one of the preceding points.

1. A method for diagnosis of an emissions related component failure of a drive machine within a motor vehicle comprising:
an internal combustion engine supplying at least two characteristic values during operation to a control apparatus;
the control apparatus comparing each characteristic value to at least one threshold value;
the control apparatus generating at least one diagnosis message if at least one characteristic value is above or below the threshold value;
a control system receiving at least one diagnosis message and provides at least one potential cause of a failure on the basis of at least one diagnosis message; and
the control system ranking each of the diagnosis messages based on relative probabilities of the failure.

2. The method of claim 1, wherein the ranking probabilities may be based on a predetermined criteria such as mathematically determined probability values or the relevance of the failure.

3. The method of claim 1, wherein the ranking is determined on the basis of each of the diagnosis messages, or on a type of the diagnosis, or a combination of the diagnosis message and the type of diagnosis.

4. The method of claim 1, wherein the drive machine can be operated in a plurality of states with a respectively constant threshold value being used for all of the operating states.

5. The method claim 1, wherein the drive machine can be operated in a plurality of states with a respectively different threshold value being used for different operating states.

6. The method of claim 1, wherein a measured value or a control loop reference variable in the form of deviation from an actual value or a measured value from a setpoint value is used.

7. The method of claim 1, wherein the trustworthiness of the ranking of the fault messages is assessed.

8. The method of claim 7, wherein the operating states for the drive machine are prespecified on the basis of the diagnosis messages, the drive machine may be operated in a prespecified sequence and/or may be operated with a prespecified chronological order of the operating states, in order to increase the trustworthiness of the ranking of the fault messages.

9. The method of claim 1, wherein at least one comparison of the characteristic value and the setpoint value indicates a fault, in which the type and/or degree of the fault being dependent on the amount by which the characteristic value exceeds or undershoots the setpoint value.

10. The method of claim 1, wherein at least one comparison of the characteristic value and the setpoint value generates the diagnosis message, the type and/or degree of the diagnosis message being dependent on the operating state of the drive machine and which state the diagnosis message is generated.

11. The method of claim 1, wherein the operating states for the drive machine are induced by the control system on the basis of the diagnosis messages, the drive machine being automatically operated in a prespecified sequence and/or with a prespecified chronological order in the operating states, in order to increase the trustworthiness of the ranking of the fault messages.
